(19) United States
(12) Patent Application Publication
(10) Pub. No.: US 2014/0189519 A1
(43) Pub. Date: Jul. 3, 2014

(54) SYSTEMS AND METHODS FOR PROVIDING WEBSITE BROWSING HISTORY TO REPEAT USERS OF A WEBSITE

(71) Applicant: W.W. GRAINGER, INC., Lake Forest, IL (US)

(72) Inventor: David Brett Powell, Haubstadt, IN (US)

(73) Assignee: W.W. GRAINGER, INC., Lake Forest, IL (US)

(21) Appl. No.: 13/774,483

(22) Filed: Feb. 22, 2013

Related U.S. Application Data
(60) Provisional application No. 61/747,650, filed on Dec. 31, 2012.

(51) Int. Cl. H04L 29/08

(52) U.S. Cl. CPC H04L 67/22
USPC 715/736

(57) ABSTRACT

A system and method can monitor interactions between a user and a website during web browsing sessions. The interactions between the user and the website are stored in a data repository, tracking cookies, or the like for later retrieval. The system and method allow the user to retrieve the monitored interactions during later browsing sessions. Session data that represents the monitored interactions may be sorted by time, by type, or by both time and type so that a user can locate particular information quickly and efficiently. The session data, moreover, may contain active links that allow the user to revisit specific monitored interactions with the click of a single button.

### CROSS REFERENCE TO RELATED APPLICATION

This application is a non-provisional application claiming priority from U.S. Provisional Application Ser. No. 61/747,650. filed Dec. 31, 2012, entitled “SYSTEMS AND METHODS FOR PROVIDING WEBSITE BROWSING HISTORY TO REPEAT USERS OF A WEBSITE” and incorporated herein by reference in its entirety.

### FIELD OF DISCLOSURE

The present disclosure relates generally to e-commerce and, more particularly, to systems and methods for providing website browsing history to repeat users of a website.

### BACKGROUND

In the art it is known to monitor interactions of a user with a website. For example, U.S. Pat. No. 6,877,007, which is incorporated herein by reference in its entirety, describes a system and method that tracks interactions of a user with content provided by a website. To this end, input made by a user as the user interacts with webpage(s) that comprise the website, such as mouse movements, button clicks, typing, etc., is streamed back to a tracking server and stored. The stored information related to the user's interactions with the website may then be analyzed and used, for example, to redesign the website so as to make it more user-friendly or more easily navigable. As a further example, U.S. Patent Publication No. 2005/0044139, which is incorporated herein by reference in its entirety, also describes a system and method in which interactions of a user with a website are monitored by keeping logs of clicks on webpage links. For this purpose, a website developer includes a link identifier in a selectable link of a webpage. When the selectable link is clicked on by a user of the website, the link identifier triggers a click tracking system to initiate click tracking for that particular link. The click on the link is then logged by a tracking server and the user is redirected to a destination specified in the link. Usage patterns may then be derived from statistics generated from the log files on the tracking server.

Despite the existence of detailed tracking methodologies such as those described in U.S. Pat. No. 6,877,007 and U.S. Patent Publication No. 2005/0044139, tracking data typically inures only to the benefit of a small group of individuals associated with the businesses operating such e-commerce websites, rather than to customers and employees (e.g., customer service representatives) who use the websites. Therefore, a need still remains for a system and method that allow a user of an e-commerce website to utilize data gained from monitoring interactions of the user with a website.

### BRIEF DESCRIPTION OF THE DRAWINGS

For a better understanding of the described systems and methods for providing browsing history to repeat users of a website, reference may be had to examples shown in the following drawings in which:

FIG. 1 is a block diagram illustrating components of an example network system in which the disclosed methods may be employed;

FIG. 2 illustrates an example webpage of a website carrying an “Account Ribbon” by which continued access to user related information is provided throughout the website;

FIG. 3 illustrates an example method for accessing information via a message field on an “Account Ribbon”;

FIG. 4 illustrates an example method for displaying information with temporal ordering;

FIG. 5 is a screen shot of an example session history webpage where users of a website can select at least one session history to review; and

FIG. 6 is a screen shot of an example webpage showing example session data corresponding to one of numerous session history trails shown in FIG. 5.

### DETAILED DESCRIPTION

To address the aforementioned need and other needs, disclosed hereinafter are systems and methods that use information gained from monitoring interactions of a user with a website to enhance subsequent website visits by the user. More particularly, in one example, by logging data about the interactions of the user with the website, the browsing history of the user can later be retrieved and presented to the user in a navigable form when the user returns to the website. Upon reviewing the specifics of the user's prior browsing history, the user may revisit certain web content with, for example, a single click of a button.

To enhance the experience of users retrieving prior browsing history, in one aspect of the disclosure the data corresponding to a particular web browsing session may be displayed and sorted in a multitude of ways that the user may control. Such session data may be sorted, for example, by browsing session, by time within browsing session, by type of session data, or the like. It will be appreciated that the session data may be sorted by more than one of these criteria as well. For instance, the system may generate a webpage that has a timeline with several channels, with each channel corresponding to different types of products. Session data showing keyword searches, product views, and/or product comparisons, for example, may be represented by blocks, symbols, icons, or other visuals on the channels of the timeline. Further, users of the website may share session data and/or may transfer session data amongst themselves. Still another aspect of the disclosed systems and methods allows users to record notes that may be shared or stored for later retrieval.

While the foregoing generally disclose systems and methods for providing website browsing history to repeat users, a better understanding of the objects, advantages, features, properties, and relationships of the systems and methods will be obtained from the following detailed description and accompanying drawings which set forth illustrative examples which are indicative of the various ways in which the principles of the disclosure may be employed.

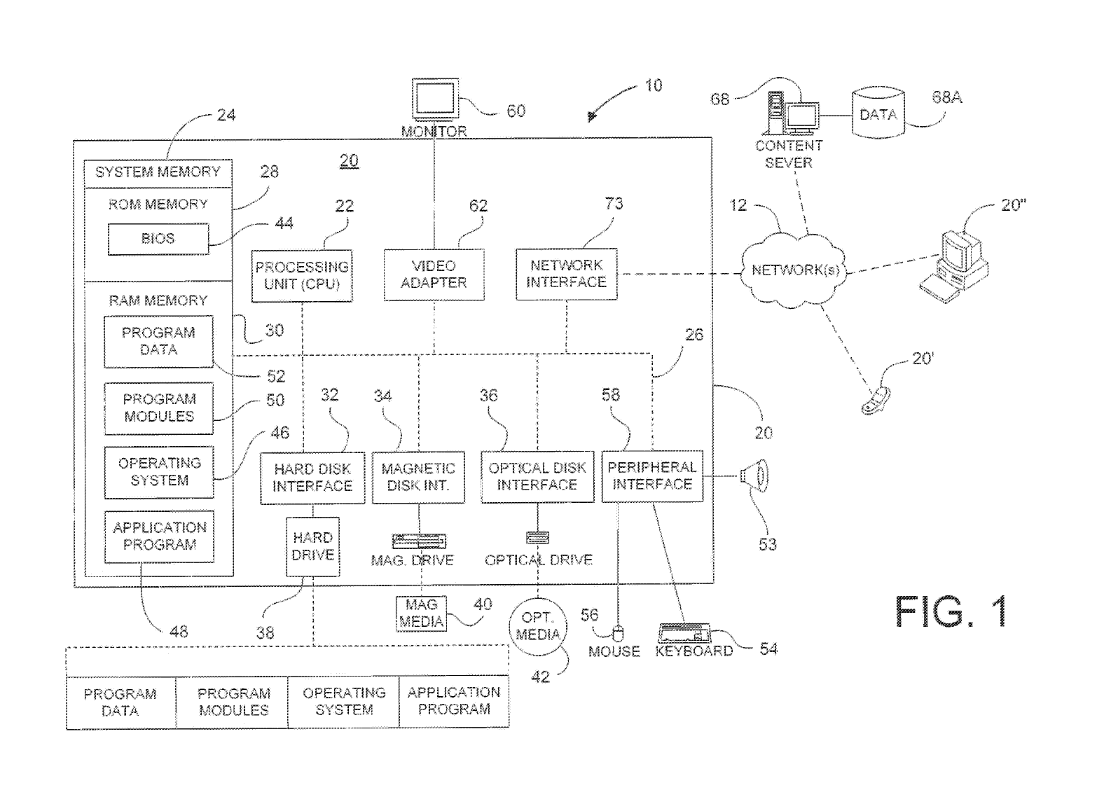

With reference now to the figures, the following discloses example systems and methods for providing easily-accessible information regarding browsing history to repeat users of a website. As illustrated in FIG. 1, a system 10 will be described in the context of a plurality of processing devices linked via a network 12, such as the World Wide Web or the Internet. In this regard, a user processing device 20, illustrated in the example form of a computer system, a user processing device 20′, illustrated in the example form of a mobile device, or a user processing device 20″, illustrated in the example form of a personal computer, provide a means for a user to access a website content server 68 via the network 12 and thereby gain access to content, such as media, data, webpages, an electronic catalog, etc., stored in a repository 68A associated with the content server 68. Furthermore, the website content server 68 and/or the user devices 20, 20′, 20″ include functionality which allows the system 10 to monitor how a user interacts with the website content offered via the website content server 68.

By way of non-limiting example, the system 10 monitors user interactions with a website by recording events, accessed content, and other data such as the following: keyword searches; model number searches; stock-keeping unit (SKU) searches; selection guides; clicked links; links that a user's mouse hovered over for a measurable period of time; accessed menus; products viewed; number of products reviewed; product images that were magnified; product comparisons; times during which webpages or other content was viewed or accessed; duration of stay; dialogs of chat sessions; audio recordings of telephonic conversations between the user and a customer service representative; identities of employees with which the user interacts; notes from users, peers (e.g., another company employee or an employee from another company), service representatives, or technical representatives; order histories; pending orders; user alerts; user preferences; personal information (e.g., created by or provided for the user); information that is related to the user via the user's membership in a group; referring websites; transfer websites; and so on. In short, the systems and methods may in some examples record virtually all measurable aspects regarding a user's visit to the website.

To enhance the user's next visit to the website, such information relevant to the user's interactions with the content offered by the website content server 68 are stored and subsequently provided to the user when the user returns to the website. In one example, information relevant to the user's interactions with the content offered by the website are stored in the repository 68A associated with the content server 68 and are further indexed to a particular user (e.g., using log-in information or other information which the content server 68 may utilize to identify the user).

In another example, the information relevant to the user's interactions with the content offered by the website may also or alternatively be stored on the user computing device 20, for example, in cases where a user has not logged onto the website content server 68 and is anonymously navigating the content provided by the website content server 68. In this case, the information relevant to the user's interactions with the content offered by the website content server 68 may be stored in, for example, a cookie placed onto the user computing device 20 using well known techniques. Since the manner by which the user device 20 is used to access and navigate the website offered by the website content server 68, the manner by which the website content server 68 makes content available to the user device 20, and the manner by which the website usage is monitored are all well known in the art, they will not be discussed herein for the sake of brevity.

For performing the functions required of the computing devices 20 and 68, the computing devices include computer executable instructions that reside in program modules which may include routines, programs, objects, components, data structures, etc. that perform particular tasks or implement particular abstract data types. Accordingly, one of ordinary skill in the art will appreciate that the computing devices may be any device having the ability to execute instructions such as, by way of example, a personal computer, mainframe computer, personal-digital assistant (“PDA”), tablet, cellular telephone, mobile device, e-reader, or the like. Furthermore, while the computing devices within the system are illustrated as respective single devices, those having ordinary skill in the art will also appreciate that the various tasks described hereinafter may be practiced in a distributed environment having multiple processing devices linked via a local or wide-area network whereby the executable instructions may be associated with and/or executed by one or more of multiple processing devices.

More particularly, the user computing device 20, which may be representative of all of the computing devices illustrated in FIG. 1, performs various tasks in accordance with the executable instructions. Thus the example user computing device 20 includes one or more processing units 22 and a system memory 24, which may be linked via a bus 26. Without limitation, the bus 26 may be a memory bus, a peripheral bus, and/or a local bus using any of a variety of well-known bus architectures. As needed for any particular purpose, the example system memory 24 includes read only memory (ROM) 28 and/or random access memory (RAM) 30. Additional memory devices may also be made accessible to the processing device 20 by means of, for example, a hard disk drive interface 32, a removable magnetic disk drive interface 34, and/or an optical disk drive interface 36. As will be understood, these devices, which would be linked to the system bus 26, respectively allow for reading from and writing to a hard disk 38, reading from or writing to a removable magnetic disk 40, and for reading from or writing to a removable optical disk 42, such as a CD/DVD ROM or other optical media. The drive interfaces and their associated tangible, computer-readable media allow for the nonvolatile storage of computer readable instructions, data structures, program modules and other data for the user computing device 20. Those of ordinary skill in the art will further appreciate that other types of tangible, computer readable media that can store data may be used for this same purpose. Examples of such media devices include, but are not limited to, magnetic cassettes, flash memory cards, digital videodisks, Bernoulli cartridges, random access memories, nano-drives, memory sticks, and other read/write and/or read-only memories.

A number of program modules may be stored in one or more of the memory/media devices. For example, a basic input/output system (BIOS) 44, containing the basic routines that help to transfer information between elements within the user computing device 20, such as during start-up, may be stored in ROM 28. Similarly, the RAM 30, hard drive 38, and/or peripheral memory devices may be used to store computer executable instructions comprising an operating system 46, one or more applications programs 48 (such as a Web browser), other program modules 50, and/or program data 52. Still further, computer-executable instructions may be downloaded to one or more of the computing devices as needed, for example, via a network connection.

A user may enter commands and information into the user computing device 20 through input devices such as a keyboard 54 and/or a pointing device 56. While not illustrated, other input devices may include a microphone, a joystick, a game pad, a scanner, a touchpad, a touch screen, a motion sensing input, etc. These and other input devices would typically be connected to the processing unit 22 by means of an interface 58 which, in turn, would be coupled to the bus 26. Input devices may be connected to the processor 22 using interfaces such as, for example, a parallel port, game port, firewire, universal serial bus (USB), or the like. To receive information from the user computing device 20, a monitor 60 or other type of display device may also be connected to the bus 26 via an interface, such as a video adapter 62. In addition to the monitor 60, the user computing device 20 may also include other peripheral output devices such as a speaker 53.

As further illustrated in FIG. 1, the user computing device 20 has logical connections to one or more remote computing devices, such as the content server 68 which, as noted above, may include many or all of the elements described above relative to the user computing device 20 as needed for performing its assigned tasks. By way of further example, the website content server 68 may include executable instructions stored on a non-transient memory device for, among other things, presenting webpages, handling search requests, providing search results, providing access to context related services, sending emails, managing lists, managing shopping carts, presenting requested user specific information, etc. Communications between the user computing device 20 and the content server 68 may be exchanged via a further processing device, such as network router 72, that is responsible for network routing. Communications with the network router 72 may be performed via a network interface component 73. Thus, within such a networked environment, e.g., the Internet, World Wide Web, LAN, or other like type of wired or wireless network, it will be appreciated that program modules depicted relative to the user computing device 20, or portions thereof, may be stored in the memory storage device(s) of the content server 68. Additionally, it will be understood that, in certain circumstances, various data of the application and/or data utilized by the content server 68 and/or user computing device 20 may reside in the “cloud.”

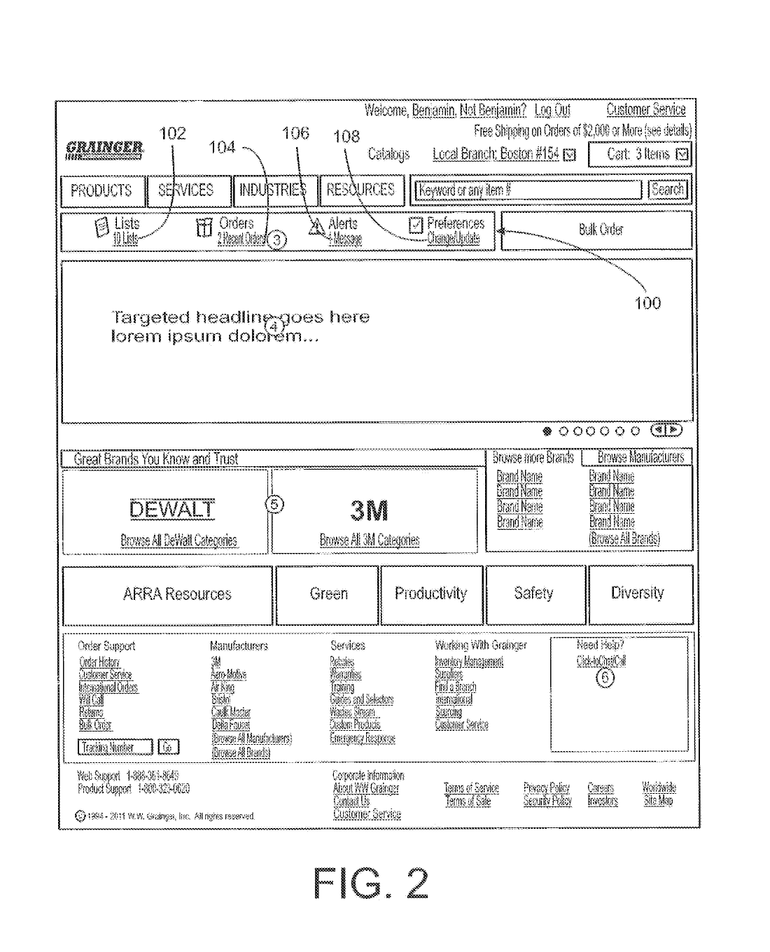

As briefly described above, the information gathered from the website usage monitoring may then be used to supplement the content being offered by the server. To provide access to this information, the webpages presented by the content server 68 may in some examples utilize an “Account Ribbon” 100, as illustrated in FIG. 2. The example “Account Ribbon” 100 includes a plurality of message fields that include links, e.g., links 102, 104, 106, and 108. In a conventional manner, the links can be interacted with by a user to thereby cause the server system 68 to present information regarding the user's prior interactions with the website.

More particularly, when one of the links presented in the “Account Ribbon” 100 is activated by a user, e.g., clicked upon, moused over, etc., the data repositories 68A may be accessed in real-time, considering information indicative of the user, to thereby extract from the data repositories 68A the information that corresponds to the selected link 102, 104, 106, and 108. Such user related information accessed in this manner from the data repositories 68A may then be presented to the user in a further webpage, in a modal associated with a currently displayed webpage, and the like without limitation.

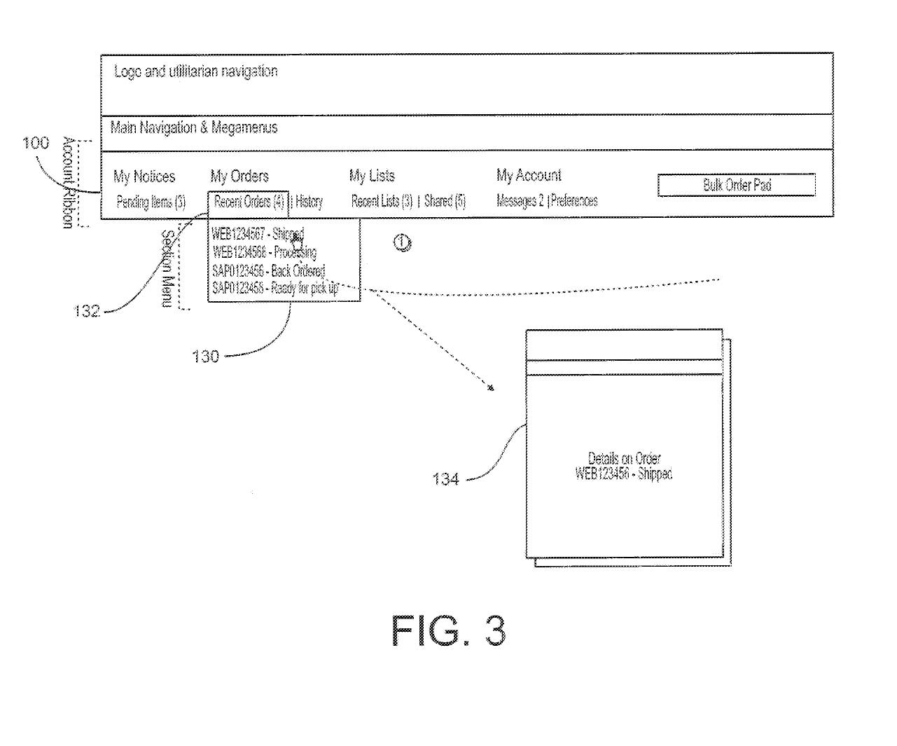

By way of further example, FIG. 3 illustrates a menu 130 being presented to a user in response to the user mousing over a “recent orders” 132 link displayed in the “Account Ribbon” 100 whereupon the user may then interact with the items within the menu 130, e.g., by clicking on, mousing over, selecting, etc. any of the four links presented—corresponding to the (4) recent orders of the user to thereby cause further related information to be presented to the user in a modal 134, e.g., the recent order information for the customer which information is retrieved from the data repository 68A in real time.

As also illustrated in FIG. 3, one or more of the message fields displayed in the “Account Ribbon” 100 may have plural related links, e.g., activatable links “Recent Orders” and “History” in the “My Orders” message display tab. When such user related information is presented to the user, the user may edit the presented information, use the information to access still further information (e.g., the information is shown in the form of links), etc. as will be described in greater detail hereinafter. Because in this example the user is known to the system server 68 (e.g., the user has logged into the system), the “Account Ribbon” 100 may present additional user related information in association with the links 102, 104, 106, and 108 as additionally illustrated in FIG. 2, e.g., to indicate a number of created lists which can be accessed via an activation of the “Lists” link 102, indicate a number of alert messages which can be accessed via an activation of the “Alerts” link 106, etc.

When the system identifies the user (e.g., the system receives valid user name/password credentials, the system recognizes an IP address, the system utilizes cookies stored locally on the user's processing device 20, etc.), the system server 68 will populate one or more of the message fields of the “Account Ribbon” 100 with the links to information that are appropriate for that user, which links may be associated with still further user specific information as described above. In practice, the “Account Ribbon” 100, which is persisted across the webpages of the website, such as for example, at or near the top thereof, functions to provide continued access to customer messages and/or to customer related information that is linked to within the “Account Ribbon” 100. As described more fully in U.S. patent application Ser. No. 13/286,594, entitled “SYSTEM AND METHOD FOR PROVIDING CONTINUED ACCESS TO USER RELATED INFORMATION” and filed on Nov. 1, 2011, which is hereby incorporated by reference in its entirety, the information contained within the “Account Ribbon” 100 may be defined by considering information that is associated with a user, e.g., the user's role within a group. It will also be appreciated that an editable “Account Ribbon” can be provided to thereby allow users to customize the “Account Ribbon” to thereby have access to the user's most desired information.

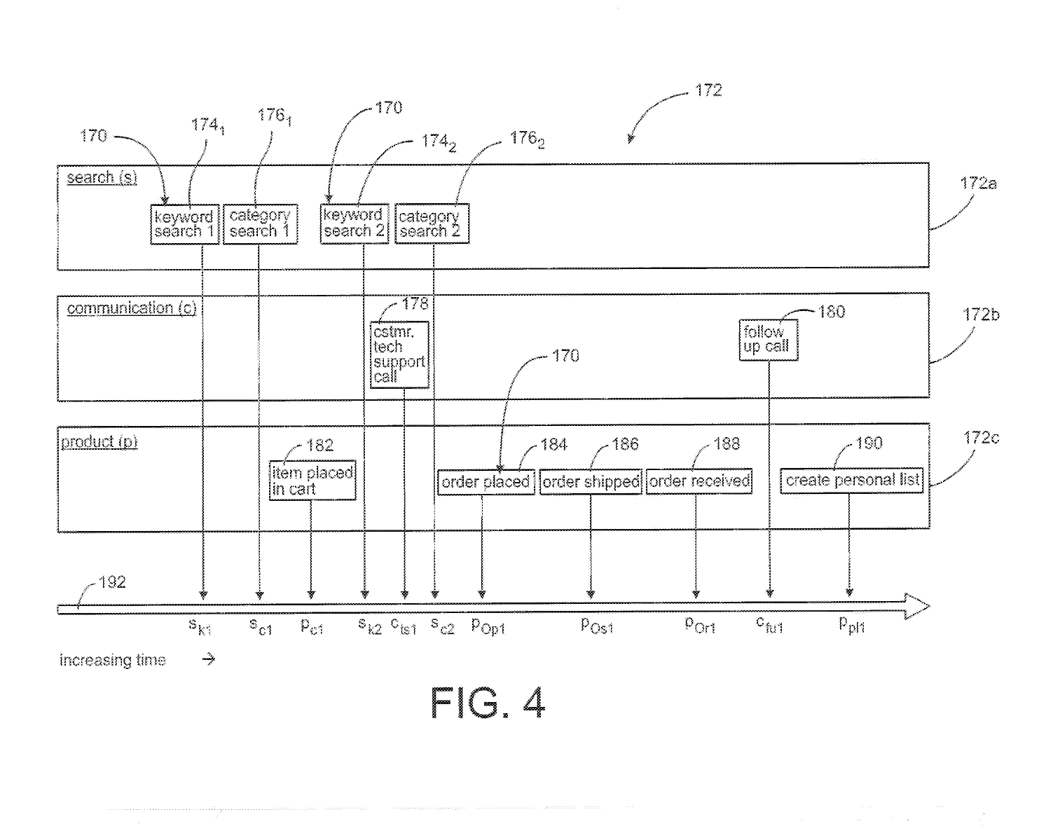

In certain examples, the “Account Ribbon” 100 is utilized to provide a user with access to information that is temporally organized. More particularly, one or more links could be provided to the “Account Ribbon” 100 whereby a user is able to access event information from the past in reverse chronological order. Of course it will be appreciated by one of ordinary skill in the art that the order presented may be any suitable order, including for example, relevance, popularity, etc. The event information may be ordered generally by time or otherwise attached to a timeline as shown by way of example in FIG. 4. Such event information may be personal to the user and/or related to the user via their membership in a group as discussed above.

More specifically, example event titles 170 in FIG. 4 have been added to a temporally organized timeline 172 of information so as to better reflect how the event relates to other events that have been monitored for the user. It should be understood that a temporally organized list or the like could also be used. As further shown in FIG. 4, the example timeline 172 of FIG. 4 includes three channels 172A, 172B, and 172C. Each of the channels 172A, 172B, and 172C represents a different type of event. For instance, the example channel 172A displays events that pertain to searches such as, for example, keyword searches 174_{1,2}, category searches 176_{1.2}, and the like. The example channel 172B displays events that pertain to communications such as, for example, a customer technical support call 178, a follow up call 180 after an order was received, and the like. Further, the example channel 172C displays events that pertain to product orders such as, for example, placing items in an online e-commerce cart 182, placing an order 184, shipping an order 186, receiving an order 188, creating personal lists of products 190, and the like.

Reviewing one or more of the example channels 172A, 172B, or 172C provides the user with perspective as to how certain types of events occurred with respect to one another. For example, considering channel 172A pertaining to search events, the user can tell that a first keyword search 174, was followed by a first category search 176₁, a second keyword search 174₂, and a second category search 176₂. Moreover, an axis 192 representing time provides the user with another perspective as to how the series of events occurred. In this example, a review of the axis 192 indicates that a sequence of events occurred as follows: a first keyword search Sₖ₁; a first category search S_{c1}; an item placed in a cart P_{c1}; a second keyword search Sₖ₂; a customer technical support call Cₜₛ₁; a second category search S_{c2}; an order placed P₀ₚ₁; an order shipped P₀ₛ₁; an order received P₀ᵣ₁; a follow up call C_{fu1}; and a personal list created Pₚₗ₁. Still a further perspective can be gained from reviewing the timeline 172 as a whole. The user can identify which types of events occur most often and how certain types of events relate to other types of events, for example.

The details of the events, e.g., results of the keyword search, a list of items placed in a shopping cart, etc., may be presented to the user in response to the user interacting with the event titles 170 as shown in the timeline 172 in FIG. 4. In the case of audio or video related events, e.g., a call placed to a customer service representative, the event details could include a replaying of the event as recorded. Interaction with the event titles 170 can include a user mousing over or otherwise selecting the event title 170, clicking on the event title 170, and the like. In addition, the events within the various channels can be user-initiated events, vendor-initiated events, and even third party-initiated events.

The present disclosure also contemplates moving or duplicating event titles 170 where convenient for the user. By way of example, instead of placing an event title indicative of a user downloading a parts manual for a previously purchased product in a location along a timeline that corresponds to a time that the product manual was actually downloaded, the event title may be moved to a location next to an event title indicative of the user purchasing the product. Users may think first to look to such locations. Furthermore, certain event titles could be duplicated along the timeline in multiple locations to better assist the user in accessing all information related to a given event. By way of further example, an event title indicative of the user talking with a technical support operator could be placed along a timeline at a location that corresponds to a time that the conversation occurred—as well as next to an event title indicative of the user purchasing the product which relates to the conversation. As will be appreciated, by use of such a method, events can be aggregated, documented, and recorded in a logical manner to thereby create for the user a better experience whereby the user can simply access all information about products and/or user needs as desired. In such a system, event titles could be organized and displayed in connection with individual channels and/or displayed in a temporal manner without being assigned to any particular channel without limitation.

To further improve the usability of the system 10, when events are recorded additional metadata about the events may also be captured and stored in the data repositories 68A. This metadata may then be made available to a search engine and thereby be used itself as a means for aggregation. By way of example, if a user searches for, compares search results, and then buys a product such as a generator, metadata about these events could be captured. Such metadata might include one or more of user name data, products viewed data, product categories visited data, keywords used data, brand names used data, catalog pages visited data, links activated data, lists interacted with data, finance related data, time and date data, as well as data indicative of any customer comments that were provided by the user (or captured from the user during a phone call, online chat, etc.) during the events (e.g., data indicative of a building the generator is to be used in, data indicative of purchase authorizer, data indicative of a project name, etc.). The search engine may then be utilized to search the data repository 68A against the captured metadata to thereby cause a logically organized list or timeline to be displayed with only those event titles that match the provided search criteria.

Thus far, the description of the system 10 has largely concerned providing the user with user related data and event data about prior interactions with a website. Still further examples of the disclosed system 10, however, are directed to providing the user with access to the user's complete browsing history as recorded during each browsing session. “Session data.” in other words, may pertain to a user's interactions with a website during browsing sessions and may involve user related data, event data, and a multitude of other types of data as described above. Further, session data may in some ways be even more granular than user related data or event data, e.g., the event data shown in FIG. 4. For instance, session data may indicate every click a user made during a browsing session with a website.

A browsing session may, for example only, correspond to a timeframe during which a user is interacting with a website. Put one way, a browsing session may commence when a user loads a webpage of a website and may terminate when the user logs-out of the website. Depending on how the website and the user's web browser are configured, the system 10 may log-out the user after a period of inactivity (e.g., a “time-out”), after the user closes a tab or web browser with the website, or after the user has requested for the system 10 to log-out the user. Thus a user browsing a website could potentially participate in a number of sessions in the same day.

To facilitate subsequent retrieval of the session data in one example, data generated during each session is stored in the data repository 68A associated with the content server 68, as described above. In some examples, session data may be grouped by session and given a unique identifier for later recall. To allow a user to recall session data from recent sessions or even from still-existing sessions, the system 10 may be configured to record session data in the repository 68A immediately as it occurs. The session data, therefore, is then available for immediate or near-immediate recall by the user. In still other examples, the session data may be stored in other locations and other forms. For instance, the system 10 may be configured to store session data in cookies that are stored locally on the user processing device 20. The system may then use the cookies to provide session data to the user, rather than retrieving the session data from the repository 68A.

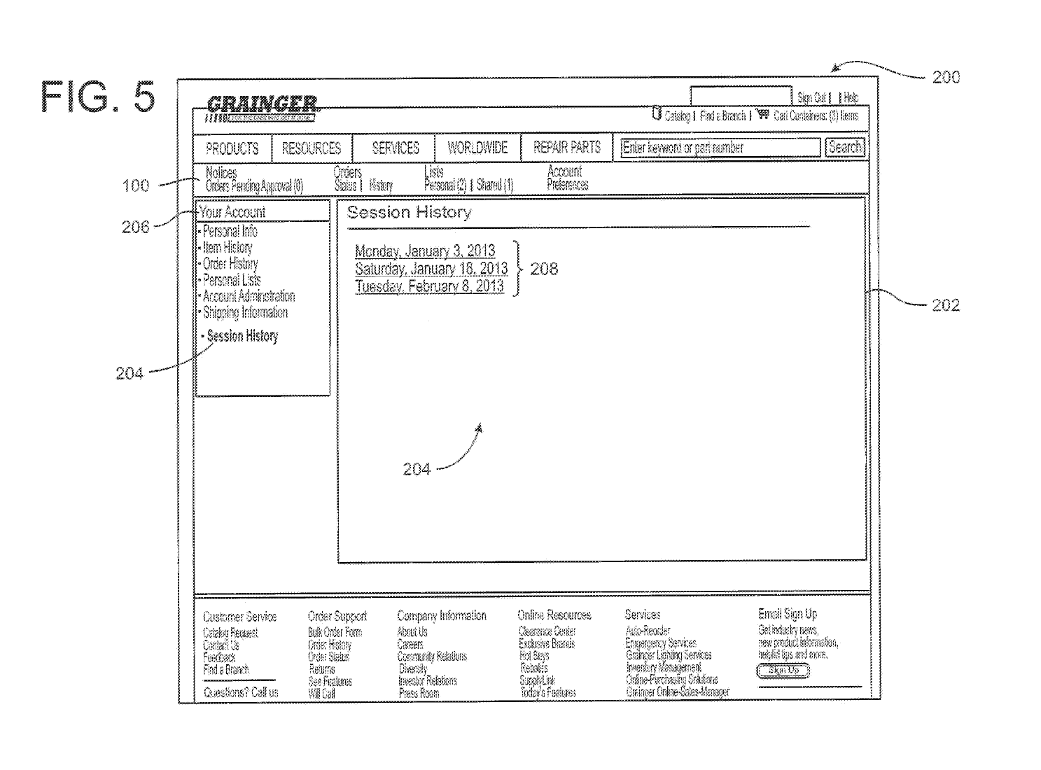

As shown in FIG. 5, an example e-commerce website 200 includes a webpage 202 that makes at least one session history 204 available to a user. In the example shown in FIG. 5, the user has selected to view account details 206 from the “Account Ribbon” 100, and has further selected to view the session histories 204. To assist the user in selecting the appropriate session data, the system 10 provides a session trail 208 on the webpage 202 for each set of data that corresponds to a web browsing session. As illustrated, the system 10 displays session trails 208 indicating that the user interacted with the e-commerce website 200 on three prior occasions. In particular, three session trails 208 appear for three separate web browsing sessions: a first on Monday, January 3; a second on Saturday, January 18; and a third on Tuesday, February 8. Although not shown in FIG. 5, the system may be configured to display a start time, an end time, or both start and end times, e.g., for web browsing sessions that occur on the same day. Likewise, in situations where a browsing session occurred earlier in the same day, for example, the system may display on the webpage 202 an indication as to the time that the session occurred. Moreover, in one example, each session trail 208 is an active link that routes the user to another webpage when clicked. Active links may be underlined or formatted in a different color to indicate to users that the link is “live.” As described below, the webpage to which the user is routed may contain the complete browsing history for the selected web browsing session.

It will be appreciated that the present disclosure contemplates a multitude of ways to sort and/or filter the session histories 204. For example, the session histories 204 may be sorted by time and/or date of session, by amount spent per session, by duration of session, and so on. Likewise, the session histories 204 may also be filtered so that only certain session histories 204 meeting certain criteria are displayed on the webpage 202. As examples, the user may wish to display only those session histories 204 in which at least one product was ordered, or only those session histories 204 in which a certain type of product was viewed, or only those session histories 204 in which the user interacted with a customer service representative, and so on. Sorts and filters, moreover, may be used individually or in combination. By way of example, suppose the user wishes to locate a session history 204 in which the user ordered a product from the website 200 early in the morning. The user can first apply a filter so that only session histories 204 are displayed in which the user placed an order. Of those session histories 204, the user can then sort by time of day, rather than date.

Still another feature that the webpage 202 may provide is a keyword search tool that allows users to keyword search at least a portion of the web content contained within the session histories 204. In one example, the keyword search tool may search a subset of the web content contained in the session histories 204 such as only links that were clicked and products that were viewed, respectively. In some examples, the web content searched includes the details associated with a particular product, item, or service. In another example, however, the keyword search tool may search all text-searchable web content that is contained within the session histories 204.

To display on the webpage 202 active links to session histories 204, session trails 208, and details thereof, as described below, the system 10 may employ standard webpage design techniques. For example and without limitation, standard HTML allows for the modification of webpage content such as adding webpage textual elements and active links. Those of ordinary skill in the art will readily appreciate how to use standard HTML programming techniques to add active links to a webpage based on a user's interactions with a website.

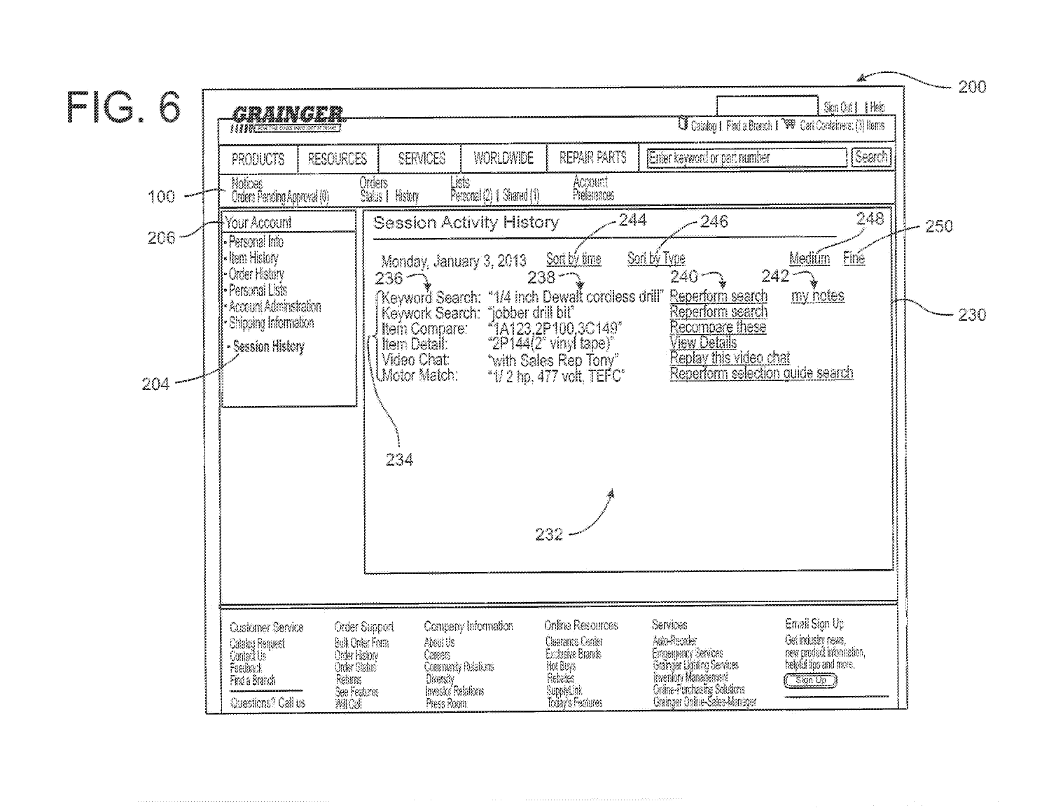

In this example, to provide the user with further session data once the user has selected a session trail 208, the system 10 routes the user to a further webpage 230 similar to that shown in FIG. 6. The example webpage 230 displays session data 232 representing a series of interactions 234 that the user had with the website 200 during a web browsing session on Monday, January 3 in this example. Generally, the session data 232 may be arranged in any suitable configuration including, for instance, a chart having rows and columns. As shown in this example, a column 236 indicates brief, high-level descriptions of interactions that were recorded by the system. A column 238 indicates further details regarding the interaction. A column 240 indicates options that can be taken with regard to particular interactions. Each option may in some examples contain an active link that allows the user to revisit a particular interaction. Finally, a column 242 indicates any notes that have been recorded with regard to a particular interaction. Similar to the options in the column 240, any notes in the column 242 may contain an active link that allows the user to view, edit, or delete any notes that were previously recorded.

To assist the user in retrieving desired information, the example system 10 provides functionality that allows the user to sort the interactions 234 by times 244 or by types 246. In one example where the interactions 234 are sorted by time, a first click of the “Sort by time” link 244 may cause the webpage 230 to display the most recent interaction 234 at the top of the chart and the least-recent interaction 234 at the bottom of the chart. A second click of the “Sort by time” link 244 may cause the webpage 230 to display the least-recent interaction 234 at the top of the chart and the most recent interaction 234 at the bottom of the chart. Assuming that the interactions shown in FIG. 6 are sorted by time from most recent to least recent, the information associated with each interaction 234 provides significant detail as to the prior browsing session. Namely, without any further clicking, a user viewing this session data 232 could tell that upon logging into the website 200, the user performed a keyword search for a “¼ inch Dewalt cordless drill” and took notes linked by a hyperlink 242 based on the results of that keyword search. The user then performed a second keyword search for a “jobber drill bit.” Without taking any notes, the user proceeded to compare three items having item numbers 1A123, 2P100, and 3C149. Thereafter, the user viewed product details for item number 2P144, which corresponds to 2-inch vinyl tape. The user then engaged in a video chat with a sales representative named, “Tony” (whose contact information may also be retrieved). Finally, before ending the session, the user performed a search for a motor based on the following product specifications: ½ horsepower, 477 volts; and totally-enclosed, fan-cooled (TEFC).

While the session data 232 in FIG. 6 is represented in the form of a list, those of ordinary skill in the art will recognize that such form is merely illustrative. Another example in which the session data 232 may be represented is similar to the temporally-arranged events shown on the timeline 172 in FIG. 4. However, a similar timeline for session data may show both events and interactions with user related data in addition to other types of data as set forth more fully above. The timeline may become particularly detailed where a “fine” level-of-detail setting is employed, as described below.

Another way in which the session data can be sorted is by type. For example, the system 10 may, by user prompt, sort the data by type of product. To illustrate, based on a chosen browsing session, the system may group session data pertaining to drills in a first group, session data pertaining to drill bits in a second group, and session data pertaining to tape in a third group. As a further example, the system 10 may sort the session data by type of function, e.g., grouping comparison matrices together, grouping detailed product views together, grouping keyword searches together, grouping video chats together, grouping online messaging conversations together, and so on. Still another way to sort session data by type is by grouping administrative-based tasks together. For instance, views of and modifications to user related data, e.g., order history and personal information, may be grouped together. Yet further, the session data may be grouped such that products that were viewed, purchased, and sent to one location are separated from products that were viewed, purchased, and sent to another location. Still other products that were viewed but not purchased may be grouped in yet another group. As demonstrated, the present disclosure contemplates a multitude of ways in which the user can direct the system to sort session data by type.

Still another example in which session data may be sorted is by both time and type. Similar to that shown in FIG. 4, for example only, a timeline with several channels may include data from a web browsing session. Each channel may represent a different type of session data, such as those discussed above, e.g., keyword searches versus communication events versus product events versus administrative activity.

A still further example of how session data may be sorted involves the capability of the system 10 to search and display session data from numerous web browsing sessions. If a user recalls previously viewing a particular staple gun during the first week in December, for example, the user may request through the website that the system retrieve the session history trails generated during the first week of December. Rather than having to review each session history trail separately, the user may review the session data for that week as a whole. Moreover, even where multiple browsing sessions are in focus, the system 10 may allow the user to sort the session data by type. Keeping with the same example, the user may sort or essentially filter the session data from the first week of December so as to view only those session data that concern staple guns. Conversely, the user may also be able to sort session data by type, with or without restrictions on session dates and times.

To provide a user with even further detailed session data 232, the example webpage 230 shown in FIG. 6 includes an option that allows the user to increase a level of detail from a “medium” level 248 to a “fine” level 250. FIG. 6 shows session data 232 at a medium level 248 of detail, which will suffice for most users on most occasions. Reviewing session data 232 at the fine level 250, by contrast, may provide an active link to every webpage, link, menu item, and the like that the user either interacted with or viewed. In addition, the session data 232 may in some examples include timestamps corresponding to the exact time, e.g., down to the second, that each webpage, link, menu item, and so on was accessed. The user may then determine how much time was spent reviewing each webpage. In the alternative or in addition, the session data 232 may include for each listed interaction an indication of how much time was spent at each webpage or the like.

With reference to the columns 240 of FIG. 6, which indicate options that can be taken with respect to each of the listed interactions 234, the system 10 allows the user to revisit each of the individual interactions 234. For example, the user can rerun keyword searches, replay video chats, review product details again, replay phone conversations, rerun parametric searches, and so forth. In some examples, clicking the active links in column the 240 will cause the system to revisit the corresponding action as it presently stands, i.e., as the user is attempting to revisit prior interactions. Thus if changes have been made to a webpage because the user previously reviewed the webpage, the user may not be able to view the prior version of the webpage. Only the current version of the webpage would be viewable. In other examples, though, the system 10 may be able to store at least certain types of session data in the repository 68A so that “cached” session data is available to the user. For example, the system 10 may be able to store the version of a webpage as the user views it originally. That stored version may later be recalled at the user's request, allowing the user to compare the current version of the webpage with the prior version of the webpage. The system may have the capability to show added or removed web content in grayscale, strikethrough, etc., similar to a track changes feature in a word processing program. This feature of the system 10 may be particularly advantageous for comparing different versions and models of products.

Those of ordinary skill in the art will appreciate that subsets of session data or entire sets of session data may be shared with or transferred to other users of the website. For example, employees of the business operating the website may share their notes with their colleagues. Likewise, users may choose to share their notes, other session data, or session histories in general with their friends, colleagues, and so on.

It will further be appreciated that the disclosed systems and methods for providing browsing history are not limited to interactions that occur between a customer and a business over the Internet. Neither are the disclosed systems and methods limited to customer usage, as employees may benefit equally if not more than customers. By way of example, the example system 10 could be implemented in a call center of a business where each customer service representative and each customer dialing in have the option to listen to prior conversations between customer service representatives and the customer. By way of further example, the systems and methods may be adapted to an enterprise resource planning (ERP) system.

While various concepts have been described in detail, it will be appreciated by those of ordinary skill in the art that various modifications and alternatives to those concepts could be developed in light of the overall teachings of the disclosure. For example, while various aspects of the present disclosure have been described in the context of functional modules and illustrated using block diagram format, it is to be understood that, unless otherwise stated to the contrary, one or more of the described functions and/or features may be integrated in a single physical device and/or a software module, or one or more functions and/or features may be implemented in separate physical devices or software modules. It will also be appreciated that a detailed discussion of the actual implementation of each aspect of the disclosure is not necessary for an enabling understanding of the disclosure. Rather, the actual implementation of the systems and methods would be well within the routine skill of an engineer, given the disclosure herein of the attributes, functionality, and inter-relationship of the various components in the system. Therefore, a person of ordinary skill in the art will be able to practice the disclosure set forth in the claims without undue experimentation. It will be additionally appreciated that the particular concepts disclosed are meant to be illustrative only and not limiting as to the scope of the disclosure which is to be given the full breadth of the appended claims and any equivalents thereof.

We claim:

1. A non-transitory computer readable media having stored thereon instructions which, when executed by a computer, perform steps comprising:
storing browsing history representative of user interactions with an electronic commerce website during at least one web browsing session;
displaying the browsing history from the at least one web browsing session, the browsing history indicating at least one of a time or a date associated with the at least one web browsing session, with the electronic commerce website identifying the at least one web browsing session; and
providing active links representing the user interactions, the active links configured to allow the user interactions to be revisited.

2. A non-transitory computer readable media as recited in claim 1, wherein the browsing history includes information related to at least two of a keyword search, a product view, a product comparison, a product category search, a model number search, a chat, a telephone call, a note made by the user at a time of the at least one monitored interaction, a clicked link, an accessed menu, or an order history.

3. A non-transitory computer readable media as recited in claim 2, wherein the browsing history is sharable or transferable between users.

4. A non-transitory computer readable media as recited in claim 1, wherein the browsing history indicates a duration of time corresponding to a period of time over which the user interactions occurred.

5. A non-transitory computer readable media as recited in claim 1, wherein the browsing history representing the user interactions is sorted by time and temporally arranged on a timeline.

6. A non-transitory computer readable media as recited in claim 5, wherein the timeline has a plurality of channels, with each of the plurality of channels corresponding to a different type of data.

7. A non-transitory computer readable media as recited in claim 1, wherein the web browsing session commences when the user loads a webpage of the electronic commerce website, wherein the browsing session terminates when the user logs-out of the electronic commerce website or after a period of inactivity.

8. A non-transitory computer readable media as recited in claim 7, wherein the browsing history representing the user interactions is stored in at least one of a data repository or a tracking cookie on a computing device of the user.

9. A non-transitory computer readable media recited in claim 8, wherein web content associated with the at least one web browsing session is keyword searchable.

10. A non-transitory computer readable media having stored thereon instructions which, when executed by a computer, perform steps comprising:
causing session data to be displayed on a webpage of an electronic commerce website, the session data representing monitored interactions of a user with the electronic commerce website during at least one browsing session, wherein the monitored interactions of the user are identifiable by the at least one browsing session, wherein the monitored interactions of the user are sorted by at least one of type or time; and
providing an active link for each of the monitored interactions of the user, each active link configured to allow the user to revisit the monitored interactions;
wherein the at least one browsing session commences when the user loads any webpage of the electronic commerce website, the at least one browsing session terminating when the user logs-out of the electronic commerce website or after a period of inactivity.

11. A non-transitory computer readable media as recited in claim 10, wherein the session data representing the monitored interactions of the user are stored in at least one of a tracking cookie on a computing device of the user or a data repository.

12. A non-transitory computer readable media as recited in claim 10, wherein the session data representing the monitored interactions of the user are sorted by time and temporally arranged on a timeline.

13. A non-transitory computer readable media as recited in claim 10, wherein the session data representing the monitored interactions of the user are sorted by type of product.

14. A non-transitory computer readable media as recited in claim 10, wherein the session data representing the monitored interactions of the user are displayable at different levels of detail.

15. A non-transitory computer readable media as recited in claim 10, wherein revisiting the monitored interactions comprises retrieving a cached webpage.

16. A non-transitory computer readable media as recited in claim 10, wherein the session data is sharable or transferable between users.

17. A non-transitory computer readable media having stored thereon instructions which, when executed by a computer, perform steps comprising:
making session data accessible upon request, the session data representing monitored interactions of a user with at least one of the computer or a customer service representative, wherein the session data representing the monitored interactions of the user indicate at least one of a time or a date at which the monitored interactions occurred; and
replaying one of the monitored interactions of the user upon request.

18. A non-transitory computer readable media as recited in claim 17, wherein the session data is accessible through at least one of a webpage or a telecommunications device.

19. The non-transitory computer readable media as recited in claim 18, wherein the session data comprises at least one note recorded by the user or the customer service representative.

20. A non-transitory computer readable media as recited in claim 17, wherein the session data is sharable or transferable.
